(19) United States
(12) Patent Application Publication
(10) Pub. No.: US 2020/0199430 A1
(43) Pub. Date: Jun. 25, 2020

(54) LOW VISCOSITY HEAT TRANSFER FLUIDS WITH INCREASING FLASH POINT AND THERMAL CONDUCTIVITY

(71) Applicant: ExxonMobil Research and Engineering Company, Annandale, NJ (US)

(72) Inventors: Smruti A. Dance, Warren, NJ (US); Andrew E. Taggi, New Hope, PA (US); Joseph S. Bair, Bangor, PA (US); Zhisheng Gao, Flemington, NJ (US)

(21) Appl. No.: 16/719,283

(22) Filed: Dec. 18, 2019

Related U.S. Application Data
(60) Provisional application No. 62/782,491, filed on Dec. 20, 2018.

(51) Int. Cl. C09K 5/10; C09K 5/20; F28F 23/00

(52) U.S. Cl. CPC C09K 5/10; F28F 23/00; C09K 5/20

(57) ABSTRACT

This disclosure relates to a heat transfer fluid having at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point and thermal conductivity of the heat transfer fluid are increased, the kinematic viscosity (KV₁₀₀) of the heat transfer fluid is decreased or essentially maintained. This disclosure also relates to a method for increasing flash point and thermal conductivity, while decreasing or essentially maintaining viscosity, of a heat transfer fluid by using the heat transfer fluid.

### CROSS-REFERENCE TO RELATED APPLICATIONS

This application claims the benefit of U.S. Provisional Application No. 62/782,491, filed on Dec. 20, 2018, the entire contents of which are incorporated herein by reference.

This application is related to U.S. Provisional Application No. 62/782,497, filed on Dec. 20, 2018, the entire contents of which are incorporated herein by reference.

### FIELD

This disclosure relates to heat transfer fluids with increasing flash point and thermal conductivity while essentially maintaining or decreasing viscosity. Also, this disclosure relates to a method for conducting heat transfer in a heating and/or cooling system using a heat transfer fluid having a mixed ester base stock system.

### BACKGROUND

Transfer of heat from local high temperature zones is a critical performance feature of lubricants and circulating fluids. In lubricated systems, examples of heat sources that require cooling include, but is not limited to, heat generated by combustion processes, heat resulting from friction within a lubricated contact, heat created by energy sources, and heat used in manufacturing processes (e.g., paper and steel making).

In some cases, specialized fluids are used for the sole purpose of removing heat from high temperature zones. Examples include coolants used in internal combustion engine applications, and transformer oils used to cool electrical distribution equipment. More recently, requirements to cool the battery and power generation systems in electric and hybrid vehicles has emerged as another application for fluids aimed at removing heat.

Traditional fluids remove heat via combinations of conductivity and convection mechanisms. The heat removed is a function of fluid properties such as heat capacity and thermal conductivity, system design including selection of materials that determine the heat flow across fluid/surface interfaces, and operational factors such as fluid flow rate and temperature difference between fluid and the high temperature zone requiring cooling.

Improving heat transfer is an emerging need as energy density of systems and equipment increases. Improving thermodynamic efficiency is often coupled with higher operating temperatures. There are emerging requirements to provide cooling fluids for hybrid and electric vehicles. Currently traditional cooling fluids, including formulated lubricants are being used. However, these have limited property ranges.

Performance of conventional heat transfer fluids is related to fluid properties such as specific heat capacity and conductivity. For most fluids, these properties fall within a narrow range and limit potential heat transfer performance.

A major challenge in heat transfer fluids is the development of alternate pathways to heat transfer performance for emerging needs as energy density of systems and equipment increases.

### SUMMARY

This disclosure relates to heat transfer fluids with increasing flash point while maintaining or decreasing viscosity. Also, this disclosure relates to a method for conducting heat transfer in a heating and/or cooling system using a heat transfer fluid having a mixed ester base stock system.

This disclosure relates in part to a heat transfer fluid having at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

This disclosure also relates in part to a method for increasing flash point, while decreasing or maintaining viscosity, of a heat transfer fluid by using as the heat transfer fluid a formulated heat transfer fluid having at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

This disclosure further relates in part to a method for increasing flash point and thermal conductivity, while decreasing or maintaining viscosity, of a heat transfer fluid by using as the heat transfer fluid a formulated heat transfer fluid having at least one partially esterified ester. The heat transfer fluid has a flash point from about 125° C. to about 225° C. as determined by ASTM D-93, a kinematic viscosity (KV₁₀₀) from about 1 to about 5 at 100° C. as determined by ASTM D-445, and a thermal conductivity at 40° C. from about 0.1 W/m·K to about 0.2 W/m·K as determined by ASTM D-2717. The at least one partially esterified ester is present in an amount such that, as the flash point and thermal conductivity of the heat transfer fluid are increased, the kinematic viscosity (KV₁₀₀) of the heat transfer fluid is decreased or essentially maintained.

This disclosure yet further relates in part to a method of heat transfer in a heating and/or cooling system. The method involves (a) providing a composition comprising at least one base heat transfer fluid in the heating and/or cooling system, and (b) conducting heat transfer between the at least one base heat transfer fluid and the heating and/or cooling system. The least one base heat transfer fluid has at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

This disclosure relates in part to a method of heat transfer that involves (a) providing an object to be heated or cooled, and (b) transferring heat to or from the object to be heated or cooled by a composition comprising at least one base heat transfer fluid. The least one base heat transfer fluid has at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

This disclosure also relates in part to a blend composition for enhanced heat transfer fluid performance. The blend composition has (i) at least one base heat transfer fluid, and (ii) one or more lubricating oils comprising a Group I, Group II, Group III, Group IV, or Group V oil. The least one base heat transfer fluid has at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

It has been surprisingly found that, in accordance with this disclosure, heat transfer fluids having a mixed ester base stock system exhibit increased flash point from about 125° C. to about 225° C. as determined by ASTM D-93, while essentially maintaining or lowering kinematic viscosity (KV₁₀₀) from about 1 to about 5 at 100° C. as determined by ASTM D-445.

It has also been surprisingly found that, in accordance with this disclosure, heat transfer fluids having a mixed ester base stock system exhibit increased thermal conductivity from about 0.1 W/m·K to about 0.2 W/m·K as determined by ASTM D-7896, and increased flash point from about 125° C. to about 225° C. as determined by ASTM D-93, while maintaining or lowering kinematic viscosity (KV₁₀₀) from about 1 to about 5 at 100° C. as determined by ASTM D-445.

Other objects and advantages of the present disclosure will become apparent from the detailed description that follows.

### BRIEF DESCRIPTION OF THE DRAWINGS

FIG. 1 shows flash point and viscosity data for base stock mixtures containing poly alphaolefin (PAO)/poly alkyleneglycol (PAG), in accordance with Example 1.

FIG. 2 shows flash point and viscosity data for base stock mixtures containing poly alphaolefin (PAO)/tripropylene glycol dipelargonate, in accordance with Example 1.

FIG. 3 shows flash point and viscosity data for base stock mixtures containing poly alphaolefin (PAO)/2-ethylhexyl palmitate, in accordance with Example 2.

FIG. 4 shows flash point and viscosity data for base stock mixtures containing octyl octanoate (fully esterified linear monoester)/neopentyl glycol sesquipelargonate (50% esterified), in accordance with Example 3.

FIG. 5 shows flash point, viscosity, and thermal conductivity data for base stock mixtures containing octyl octanoate (fully esterified linear monoester)/trimethylolpropane pelargonate (66.7% esterified), in accordance with Example 3.

FIG. 6 shows flash point and viscosity data for base stock mixtures containing trimethyl-1-hexyl trimethylhexanoate (fully esterified)/2-ethylhexyl palmitate (fully esterified), in accordance with Example 4.

FIG. 7 shows flash point and viscosity data for base stock mixtures containing trimethyl-1-hexyl trimethylhexanoate (fully esterified)/trimethylolpropane pelargonate (66.7% esterified), in accordance with Example 4.

FIG. 8 shows flash point, viscosity and thermal conductivity data for base stock mixtures containing trimethyl-1-hexyl trimethylhexanoate (fully esterified)/neopentyl glycol sesquipelargonate (50% esterified), in accordance with Example 4.

FIG. 9 shows thermal conductivity data for trimethylolpropane pelargonate, alkyl naphthalene, poly alphaolefin (PAO), and poly alkyleneglycol (PAG) base stocks, in accordance with Example 5.

FIG. 10 shows thermal conductivity, electrical conductivity, density, pour point and viscosity data for heat transfer fluids based on octyloctanoate and trimethylolpropane pelargonate −66.7% esterified, and a stabilizer dialkyldiphenylamine, in accordance with Example 6.

### DETAILED DESCRIPTION

### Definitions

“About” or “approximately.” All numerical values within the detailed description and the claims herein are modified by “about” or “approximately” the indicated value, and take into account experimental error and variations that would be expected by a person having ordinary skill in the art.

“Major amount” as it relates to components included within the lubricating oils of the specification and the claims means greater than or equal to 50 wt. %, or greater than or equal to 60 wt. %, or greater than or equal to 70 wt. %, or greater than or equal to 80 wt. %, or greater than or equal to 90 wt. % based on the total weight of the lubricating oil.

“Minor amount” as it relates to components included within the lubricating oils of the specification and the claims means less than 50 wt. %, or less than or equal to 40 wt. %, or less than or equal to 30 wt. %, or greater than or equal to 20 wt. %, or less than or equal to 10 wt. %, or less than or equal to 5 wt. %, or less than or equal to 2 wt. %, or less than or equal to 1 wt. %, based on the total weight of the lubricating oil.

“Essentially free” as it relates to components included within the lubricating oils of the specification and the claims means that the particular component is at 0 weight % within the lubricating oil, or alternatively is at impurity type levels within the lubricating oil (less than 100 ppm, or less than 20 ppm, or less than 10 ppm, or less than 1 ppm).

“Other lubricating oil additives” as used in the specification and the claims means other lubricating oil additives that are not specifically recited in the particular section of the specification or the claims. For example, other lubricating oil additives may include, but are not limited to, antioxidants, detergents, dispersants, antiwear additives, corrosion inhibitors, viscosity modifiers, metal passivators, pour point depressants, seal compatibility agents, antifoam agents, extreme pressure agents, friction modifiers and combinations thereof.

“Other mechanical component” as used in the specification and the claims means an electric vehicle component, a hybrid vehicle component, a power train, a driveline, a transmission, a gear, a gear train, a gear set, a compressor, a pump, a hydraulic system, a bearing, a bushing, a turbine, a piston, a piston ring, a cylinder liner, a cylinder, a cam, a tappet, a lifter, a gear, a valve, or a bearing including a journal, a roller, a tapered, a needle, and a ball bearing.

“Hydrocarbon” refers to a compound consisting of carbon atoms and hydrogen atoms.

“Alkane” refers to a hydrocarbon that is completely saturated. An alkane can be linear, branched, cyclic, or substituted cyclic.

“Olefin” refers to a non-aromatic hydrocarbon comprising one or more carbon-carbon double bond in the molecular structure thereof.

“Mono-olefin” refers to an olefin comprising a single carbon-carbon double bond.

“Cn” group or compound refers to a group or a compound comprising carbon atoms at total number thereof of n. Thus, “Cm-Cn” group or compound refers to a group or compound comprising carbon atoms at a total number thereof in the range from m to n. Thus, a C1-C50 alkyl group refers to an alkyl group comprising carbon atoms at a total number thereof in the range from 1 to 50.

“Carbon backbone” refers to the longest straight carbon chain in the molecule of the compound or the group in question. “Branch” refer to any substituted or unsubstituted hydrocarbyl group connected to the carbon backbone. A carbon atom on the carbon backbone connected to a branch is called a “branched carbon.”

“Epsilon-carbon” in a branched alkane refers to a carbon atom in its carbon backbone that is (i) connected to two hydrogen atoms and two carbon atoms and (ii) connected to a branched carbon via at least four (4) methylene (CH₂) groups. Quantity of epsilon carbon atoms in terms of mole percentage thereof in a alkane material based on the total moles of carbon atoms can be determined by using, e.g., ¹³C NMR.

“Alpha-carbon” in a branched alkane refers to a carbon atom in its carbon backbone that is with a methyl end with no branch on the first 4 carbons. It is also measured in mole percentage using ¹³C NMR.

“T/P methyl” in a branched alkane refers to a methyl end and a methyl in the 2 position. It is also measured in mole percentage using ¹³C NMR.

“P-methyl” in a branched alkane refers to a methyl branch anywhere on the chain, except in the 2 position. It is also measured in mole percentage using ¹³C NMR.

“SAE” refers to SAE International, formerly known as Society of Automotive Engineers, which is a professional organization that sets standards for internal combustion engine lubricating oils.

“SAE J300” refers to the viscosity grade classification system of engine lubricating oils established by SAE, which defines the limits of the classifications in rheological terms only.

“Base stock” or “base oil” interchangeably refers to an oil that can be used as a component of lubricating oils, heat transfer oils, hydraulic oils, grease products, and the like.

“Lubricating oil” or “lubricant” interchangeably refers to a substance that can be introduced between two or more surfaces to reduce the level of friction between two adjacent surfaces moving relative to each other. A lubricant base stock is a material, typically a fluid at various levels of viscosity at the operating temperature of the lubricant, used to formulate a lubricant by admixing with other components. Non-limiting examples of base stocks suitable in lubricants include API Group I, Group II, Group III, Group IV, and Group V base stocks. PAOs, particularly hydrogenated PAOs, have recently found wide use in lubricants as a Group IV base stock, and are particularly preferred. If one base stock is designated as a primary base stock in the lubricant, additional base stocks may be called a co-base stock.

All kinematic viscosity values in this disclosure are as determined pursuant to ASTM D445. Kinematic viscosity at 100° C. is reported herein as KV100, and kinematic viscosity at 40° C. is reported herein as KV40. Unit of all KV100 and KV40 values herein is cSt unless otherwise specified. When describing the kinematic viscosity at 100° C. is “essentially” maintained, the kinematic viscosity at 100° C. is expected to vary less than 0.2 cSt as measured by ASTM D445.

All viscosity index (“VI”) values in this disclosure are as determined pursuant to ASTM D2270.

All Noack volatility (“NV”) values in this disclosure are as determined pursuant to ASTM D5800 unless specified otherwise. Unit of all NV values is wt %, unless otherwise specified.

All pour point values in this disclosure are as determined pursuant to ASTM D5950 or D97.

All CCS viscosity (“CCSV”) values in this disclosure are as determined pursuant to ASTM 5293. Unit of all CCSV values herein is millipascal second (mPa·s), which is equivalent to centipoise), unless specified otherwise. All CCSV values are measured at a temperature of interest to the lubricating oil formulation or oil composition in question. Thus, for the purpose of designing and fabricating engine oil formulations, the temperature of interest is the temperature at which the SAE J300 imposes a minimal CCSV.

All percentages in describing chemical compositions herein are by weight unless specified otherwise. “Wt. %” means percent by weight.

### Heat Transfer Fluids of this Disclosure

The compositions of this disclosure containing the mixed ester heat transfer fluids have advantageous characteristics including low volatility, high flash point and low viscosity. The mixed ester heat transfer fluids of this disclosure have a high thermal capacity to protect the fluid from degradation at high temperatures.

This disclosure provides high performance heat transfer fluids based on a mixed ester system. Examples include fluid mixtures of 1-20% of mid- to high hydroxyester and 80-99% fully esterified materials. In addition, combinations of 1-20% mid-to high hydroxyester and 80-99% highly branched esters are also beneficial. In certain cases, lower levels of highly branched esters from 1-20% in combination with 80-99% mid-to high hydroxyester is also beneficial.

Heat transfer fluids having a mixed ester system can be blended with lubricating oil base fluids in order to optimize fluid flow properties while retaining the heat transfer benefits, as described herein. In an embodiment, the heat transfer fluids having a mixed ester system can be blended with lubricating oil base fluids, to form bimodal blends.

In addition to the base heat transfer fluids, the compositions of this disclosure can contain additives. Illustrative additives useful in the heat transfer fluids of this disclosure include, for example, corrosion inhibitors, thermal stabilizers, viscosity modifiers, pH stabilizers or buffers, antiscaling additives, biocides, and the like.

Corrosion inhibitors are preferably selected from tolyl triazole, benzotriazole, aspartic acid, sebacic acid, borax, molybdic oxide, sodium molybdate dihydrate, morpholine, or a combination of two or more thereof. Sodium molybdate dihydrate is an advantageous additive in aluminum (Al) containing systems since it works especially well as an Al corrosion inhibitor. The total amount of corrosion inhibitor in the heat transfer fluid is preferably from 0.01 to 0.5% (w/w).

Thermal stabilizers are preferably selected from tetra (2-hydroxypropyl) ethylenediamine (also known as quadrol polyol), polyethyleneglycol, pentaerythritol or a combination of two or more thereof. The total amount of thermal stabilizer in the heat transfer fluid is preferably from 0.1 to 1% (w/w). Sodium hydroxide may also be added as a stabilizer in an amount of less than 0.05% (w/w), although this is in addition to any thermal stabilizer that may be present. Sodium hydroxide serves to stabilize the glycerine component of the composition and is preferably present in an amount of at least 0.01% (w/w). The preferred stabilizer for ester based coolants include dialkyldiphenylamine and phenolic antioxidants. More preferably, the stabilizer contains dialkyldiphenylamine. The total amount of stabilizer in the heat transfer fluid is preferably from 0.1 to 1% (w/w).

A viscosity modifier in the heat transfer fluid assists in controlling the viscosity of the fluid to an acceptable level. The specific viscosity modifier and quantities of viscosity modifier used can have the advantage of providing a desired viscosity and also advantageous characteristics with regard to the inhibition of corrosion and the stability of the heat transfer fluids, in particular thermal stability. They also can permit the use of known anti-corrosion and anti-scaling additives. Illustrative viscosity modifiers include, for example, polymethacrylate, and the like. The total amount of viscosity modifier in the heat transfer fluid is preferably from 0.1 to 5% (w/w).

Illustrative biocides include, for example, nipacide, and the like. The total amount of biocide in the heat transfer fluid is preferably from 0.01 to 0.5% (w/w).

The additives useful in this disclosure do not have to be soluble in the heat transfer fluids. Insoluble additives in base fluids can be dispersed in the heat transfer fluids of this disclosure.

The types and quantities of performance additives used in combination with the instant disclosure in heat transfer fluids are not limited by the examples shown herein as illustrations.

When heat transfer fluid compositions contain one or more of the additives discussed above, the additive(s) are blended into the composition in an amount sufficient for it to perform its intended function.

The foregoing additives are all commercially available materials. These additives may be added independently but are usually precombined in packages which can be obtained from suppliers of heat transfer fluid additives. Additive packages with a variety of ingredients, proportions and characteristics are available and selection of the appropriate package will take the requisite use of the ultimate composition into account.

The base heat transfer fluid as disclosed herein is described in relation to the % (w/w) of each of the components added. It will be appreciated that the balance of these components is preferably the base heat transfer fluid. During manufacture, some unavoidable impurities may be introduced into the fluid as well. Preferably such unavoidable impurities should be less than 5% (w/w), preferably less than 1% (w/w), more preferably less than 0.1% (w/w) and most preferably less than 0.01% (w/w). Ideally there are no unavoidable impurities present.

The heat transfer fluids of this disclosure have a freezing point of at least greater than about −50° C., or greater than about −45° C., or greater than about −40° C., as determined by ASTM D1777-17, a boiling point of greater than about 100° C., or greater than about 125° C., or greater than about 150° C., as determined by ASTM D1120-17, a kinematic viscosity (KV₁₀₀) from about 1 to about 5, or from about 1.1 to about 4.0, or from about 1.1 to about 3.0, at 100° C. as determined by ASTM D-445and a flash point of at least 125° C., or at least 150° C., or at least 175° C., or at least 200° C., or at least 225° C., as determined by ASTM D93.

A heat transfer process can be carried out at a temperature from about −40° C. to greater than about 80° C., or from about −35° C. to greater than about 90° C., or from about −30° C. to greater than about 100° C., and/or a pressure from about 50 MP to about 500 MP, or from about 60 MP to about 475 MP, or from about 70 MP to about 450 MP.

In an embodiment, this disclosure also relates to a heat transfer fluid having at least one first ester that is partially esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

In another embodiment, this disclosure also relates to a heat transfer fluid having at least one first ester that is fully esterified, and at least one second ester that is branched and is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

In still another embodiment, this disclosure also relates to a method for increasing flash point, while decreasing or maintaining viscosity, of a heat transfer fluid by using as the heat transfer fluid a formulated heat transfer fluid having at least one first ester that is partially esterified, and at least one second ester that is fully esterified. The heat transfer fluid has a flash point from about 125° C. to about 225° C. as determined by ASTM D-93, and a viscosity (Kv₁₀₀) from about 1 to about 5 at 100° C. as determined by ASTM D-445. The at least one first ester and the at least one second ester are present in an amount such that, as the flash point of the heat transfer fluid is increased, the viscosity (Kv₁₀₀) of the heat transfer fluid is decreased or essentially maintained.

In yet another embodiment, this disclosure also relates to a method for increasing flash point, while decreasing or maintaining viscosity, of a heat transfer fluid by using as the heat transfer fluid a formulated heat transfer fluid having at least one first ester that is branched and is fully esterified, and at least one second ester that is fully esterified. The heat transfer fluid has a flash point from about 125° C. to about 225° C. as determined by ASTM D-93, and a kinematic viscosity (KV₁₀₀) from about 1 to about 5 at 100° C. as determined by ASTM D-445. The at least one first ester and the at least one second ester are present in an amount such that, as the flash point of the heat transfer fluid is increased, the kinematic viscosity (KV₁₀₀) of the heat transfer fluid is decreased or essentially maintained.

### Base Heat Transfer Fluids

The base heat transfer fluids of this disclosure can be comprised of mixed ester systems. Suitable mixed ester base systems include, for example, fully esterified esters, partially esterified esters, branched fully esterified esters, and branched partially esterified esters.

In an embodiment, the partially esterified esters comprise a partially esterified polyol ester of a monocarboxylic acid.

The partially esterified esters can be derived by reacting one or more polyhydric alcohols with one or more monocarboxylic acids. The one or more polyhydric alcohols can be branched or unbranched and include, for example, neopentyl glycol, trimethylol ethane, 2-methyl-2-propyl-1,3-propanediol, trimethylol propane, pentaerythritol, dipentaerythritol, tripentaerythritol, or tetrapentaerythritol. The one or more monocarboxylic acids can be branched or unbranched and include, for example, acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid, caprylic acid, capric acid, lauric acid, myristic acid, palmitic acid, stearic acid, arachic acid, behenic acid, or oleic acid.

Illustrative partially esterified esters include, for example, partially esterified neopentyl glycol sesquipelargonate, partially esterified trimethylolpropane pelargonate, partially esterified neopentyl glycol ester, partially esterified 2-methyl-2-propyl-1,3-propanediol ester, partially esterified trimethylol ethane ester, partially esterified trimethylol propane ester, partially esterified pentaerythritol ester, partially esterified dipentaerythritol ester, partially esterified tripentaerythritol ester, partially esterified tetrapentaerythritol ester, or mixtures thereof. The partially esterified esters can be branched or unbranched.

Reaction conditions for the reaction of the one or more polyhydric alcohols with the one or more monocarboxylic acids, such as temperature, pressure and contact time, may also vary greatly and any suitable combination of such conditions may be employed herein. The reaction temperature may range between about 25° C. to about 250° C., and preferably between about 30° C. to about 200° C., and more preferably between about 60° C. to about 150° C. Normally the reaction is carried out under ambient pressure and the contact time may vary from a matter of seconds or minutes to a few hours or greater. The reactants can be added to the reaction mixture or combined in any order. The stir time employed can range from about 0.5 to about 48 hours, preferably from about 1 to 36 hours, and more preferably from about 2 to 24 hours.

The fully esterified esters can be derived by reacting one or more monoalkanoic acids with one or more monoalkanols. The one or more monoalkanoic acids can be branched or unbranched and include, for example, butanoic acid, pentanoic acid, hexanoic acid, heptanoic acid, octanoic acid, nonanoic acid, decanoic acid, undeanoic acid, dodecanoic acid, tridecanoic acid, tetradecanoic acid, pentadecanoic acid, hexadecanoic acid, and their isomers. The one or more monalkanols can be branched or unbranched and include, for example, butyl alcohol, pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Illustrative fully esterified esters include, for example, dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, tripropylene glycol dipelargonate, 2-ethylhexyl palmitate, octyl octanoate, trimethyl-1-hexyl trimethylhexanoate, or mixtures thereof. The fully esterified esters can be branched or unbranched.

Reaction conditions for the reaction of the one or more monoalkanoic acids with the one or more monoalkanols, such as temperature, pressure and contact time, may also vary greatly and any suitable combination of such conditions may be employed herein. The reaction temperature may range between about 25° C. to about 250° C., and preferably between about 30° C. to about 200° C., and more preferably between about 60° C. to about 150° C. Normally the reaction is carried out under ambient pressure and the contact time may vary from a matter of seconds or minutes to a few hours or greater. The reactants can be added to the reaction mixture or combined in any order. The stir time employed can range from about 0.5 to about 48 hours, preferably from about 1 to 36 hours, and more preferably from about 2 to 24 hours.

The fully esterified esters and partially esterified esters useful in this disclosure can exhibit a wide range of amount of esterification, for example, esterification amount of at least 100%, or at least about 90%, or at least about 80%, or at least about 70%, or at least about 60%, or at least about 50%, or at least about 40%, or at least about 30%, or at least about 20%, or at least about 10%.

As used herein, a partially esterified ester would be when you react a polyol with fewer equivalents of carboxylic acid than the total number of hydroxyls present on the polyol. For example, if the polyol has 3 hydroxyl groups, and you add fewer than 3 equivalents of carboxylic acid, then the polyol will be “partially esterified” in that the reaction will be incomplete due to insufficient carboxylic acid and there will be some free hydroxyl groups.

As used herein, low to mid-hydroxyesters include those esters having at least about 50% esterification, and high-hydroxyesters include those esters having more than about 50% esterification (e.g., 66.7% esterification).

Illustrative high performance heat transfer fluids based on a mixed ester system include, for example, fluid mixtures of 1-20% of mid- to high hydroxyester and 80-99% fully esterified materials. In addition, combinations of 1-20% mid-to high hydroxyester and 80-99% highly branched esters are also beneficial. In certain cases, lower levels of highly branched esters from 1-20% in combination with 80-99% mid-to high hydroxyester is also beneficial.

The heat transfer fluids of this disclosure conveniently have a kinematic viscosity, according to ASTM standards, of about 1 cSt to about 5 cSt (or mm²/s) at 100° C. and preferably of about 1.1 cSt to about 4.5 cSt (or mm²/s) at 100° C., often more preferably from about 1.1cSt to about 3.0 cSt at 100° C.

Mixtures of heat transfer fluids may be used if desired. Bi-modal, tri-modal, and additional combinations of mixtures of heat transfer fluids and optional Group I, II, III, IV, and/or V base stocks may be used if desired. With mixtures of heat transfer fluids and Group I, II, III, IV, and/or V base stocks, the heat transfer fluid is present is an amount ranging from about 5 to about 99 weight percent or from about 10 to about 95 weight percent, preferably from about 50 to about 99 weight percent or from about 70 to about 95 weight percent, and more preferably from about 85 to about 95 weight percent, based on the total weight of the composition. Preferably, with mixtures of heat transfer fluids and Group I, II, III, IV, and/or V base stocks, the heat transfer fluid is present is an amount ranging from about 50 to about 99 weight percent or from about 55 to about 95 weight percent, preferably from about 60 to about 99 weight percent or from about 70 to about 95 weight percent, and more preferably from about 85 to about 95 weight percent, based on the total weight of the composition.

The heat transfer fluid typically is present in an amount ranging from about 5 to about 99 weight percent or from about 10 to about 95 weight percent, preferably from about 50 to about 99 weight percent or from about 70 to about 95 weight percent, and more preferably from about 85 to about 95 weight percent, based on the total weight of the composition.

Examples of techniques that can be employed to characterize the compositions formed by the process described above include, but are not limited to, analytical gas chromatography, nuclear magnetic resonance, thermogravimetric analysis (TGA), inductively coupled plasma mass spectrometry, differential scanning calorimetry (DSC), volatility and viscosity measurements.

### Blends of Base Heat Transfer Fluids and Lubricating Oil Base Fluids

A wide range of optional lubricating base fluids is known in the art. Optional lubricating base fluids that are useful in the present disclosure are natural oils, mineral oils and synthetic oils, and unconventional oils (or mixtures thereof) can be used unrefined, refined, or rerefined (the latter is also known as reclaimed or reprocessed oil). Unrefined oils are those obtained directly from a natural or synthetic source and used without added purification. These include shale oil obtained directly from retorting operations, petroleum oil obtained directly from primary distillation, and ester oil obtained directly from an esterification process. Refined oils are similar to the oils discussed for unrefined oils except refined oils are subjected to one or more purification steps to improve at least one lubricating oil property. One skilled in the art is familiar with many purification processes. These processes include solvent extraction, secondary distillation, acid extraction, base extraction, filtration, and percolation. Rerefined oils are obtained by processes analogous to refined oils but using an oil that has been previously used as a feed stock.

Groups I, II, III, IV and V are broad base oil stock categories developed and defined by the American Petroleum Institute (API Publication 1509; www.API.org) to create guidelines for lubricant base oils. Group I base stocks have a viscosity index of between about 80 to 120 and contain greater than about 0.03% sulfur and/or less than about 90% saturates. Group II base stocks have a viscosity index of between about 80 to 120, and contain less than or equal to about 0.03% sulfur and greater than or equal to about 90% saturates. Group III stocks have a viscosity index greater than about 120 and contain less than or equal to about 0.03% sulfur and greater than about 90% saturates. Group IV includes polyalphaolefins (PAO). Group V base stock includes base stocks not included in Groups I-IV. The table below summarizes properties of each of these five groups.

| | Base Oil Properties | | |
|---|---|---|---|
| | Saturates | Sulfur | Viscosity Index |
| Group I | <90 and/or | >0.03% and | ≥80 and <120 |
| Group II | ≥90 and | ≤0.03% and | ≥80 and <120 |
| Group III | ≥90 and | ≤0.03% and | ≥120 |

| | |
|---|---|
| Group IV | polyalphaolefins (PAO) |
| Group V | All other base oil stocks not included in Groups I, II, III or IV |

Optional base oils for use in the heat transfer fluids of the present disclosure are any of the variety of oils corresponding to API Group I, Group II, Group III, Group IV, and Group V oils and mixtures thereof, preferably API Group II, Group III, Group IV, and Group V oils and mixtures thereof, more preferably the Group III to Group V base oils due to their volatility, stability, viscometric and cleanliness features.

The optional base oil is typically is present in an amount ranging from about 5 to about 99 weight percent or from about 10 to about 95 weight percent, preferably from about 50 to about 99 weight percent or from about 70 to about 95 weight percent, and more preferably from about 85 to about 95 weight percent, based on the total weight of the composition. The optional base oil may be selected from any of the synthetic or natural oils typically used as crankcase lubricating oils for spark-ignited and compression-ignited engines. The optional base oil conveniently has a kinematic viscosity, according to ASTM standards, of about 1 cSt to about 5 cSt (or mm²/s) at 100° C. and preferably of about 1.0 cSt to about 4.0 cSt (or mm²/s) at 100° C., often more preferably from about 1.0 cSt to about 3 cSt. Mixtures of synthetic and natural base oils may be used if desired. Bi-modal, tri-modal, and additional combinations of mixtures of Group I, II, III, IV, and/or V base stocks may be used if desired.

The blends of heat transfer base fluids and lubricating oil base fluids useful in the present disclosure may additionally contain one or more of the other commonly used performance additives as described herein.

The blends of heat transfer fluids with lubricating oil base fluids can optimize fluid flow properties while retaining the heat transfer benefits, as described herein.

The blends of heat transfer base fluids and lubricating oil base fluids useful in the present disclosure may additionally contain one or more of the other commonly used performance additives as described herein.

The heat transfer fluids of this disclosure can be used to heat or cool an object and can be used in heating and cooling systems for heating and cooling residential, commercial and industrial buildings. The heat transfer fluids can be used in an engine cooling system. To cool a vehicle having a radiator and an engine block, the heat transfer fluid is moved through the engine block to transfer heat from the engine block to the heat transfer fluid. The heat transfer fluid then moves through the radiator to transfer heat from the heat transfer fluid to the radiator and to air surrounding the radiator.

When used in a heating and cooling system for a building, the heat transfer fluid can be inserted into the pipes of the heating and cooling system. The heating or cooling systems can include a boiler, pipes, a radiator, and a pump. The heat transfer fluid is then moved into contact with the boiler so that heat is transferred from the boiler to the heat transfer fluid. The heat transfer fluid then moves through the radiators of the heating and cooling system and heat is transferred from the heat transfer fluid to the radiators. Heat is then transferred from the radiators to air surrounding the radiators.

The heat transfer fluids of this disclosure can be stored in steel, plastic, poly or stainless steel containers. The heat transfer fluids can be pumped from the storage container into the heating and cooling systems or the objects to be heated or cooled by most types of pumps well known in the art such as gear, air, diaphragm, roller, or piston.

The following non-limiting examples are provided to illustrate the disclosure.

### EXAMPLES

Typical base stock mixtures have a logarithmic viscosity relationship as well as a logarithmic volatility relationship. It is known that higher base stock viscosity correlates to lower volatility, lower vapor pressure and higher flash point. In accordance with this disclosure, it is advantageous to have base stock mixtures that deviate from this traditional relationship such that low volatility/high flash point are achieved with low viscosity. In particular, the base stocks of this disclosure that exhibit properties such as high flash point and low viscosity are extremely advantageous for improved fuel economy, minimizing power loss due to friction and ensuring safe operation of high power engines operating at high temperature.

### Example 1

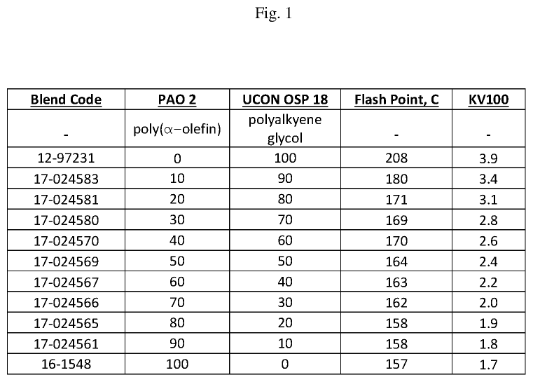

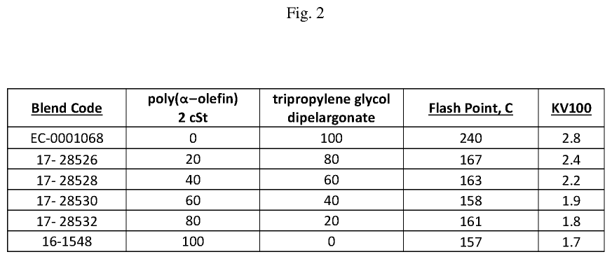

Comparative examples illustrating traditional flash point and viscosity relationships are shown in FIGS. 1 and 2. As shown in FIGS. 1 and 2, base stock mixtures containing poly alphaolefin (PAO)/poly alkyleneglycol (PAG) and poly alphaolefin (PAO)/tripropylene glycol dipelargonate exhibit no unexpected increase in flash point at low viscosity. Flash point was determined by ASTM D-93. Kinematic viscosity (KV₁₀₀) was determined by ASTM D-445.

FIG. 1 shows flash point and viscosity data for base stock mixtures containing poly alphaolefin (PAO)/poly alkyleneglycol (PAG). The mixtures exhibit traditional flash point and viscosity relationships, that is a higher base stock viscosity correlates to lower volatility, lower vapor pressure and higher flash point.

FIG. 2 shows flash point and viscosity data for base stock mixtures containing poly alphaolefin (PAO)/tripropylene glycol dipelargonate. The mixtures exhibit traditional flash point and viscosity relationships, that is a higher base stock viscosity correlates to lower volatility, lower vapor pressure and higher flash point.

### Example 2

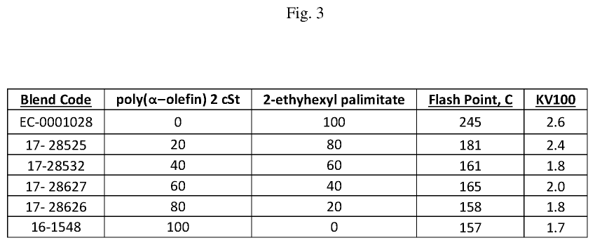

As shown in FIG. 3, base stock mixtures containing poly alphaolefin (PAO)/2-ethylhexyl palmitate exhibit traditional flash point relationships. However, the viscosity relationship of the mixture containing 60% ester is lower than expected. Flash point was determined by ASTM D-93. Kinematic viscosity (KV₁₀₀) was determined by ASTM D-445.

FIG. 3 shows flash point and viscosity data for base stock mixtures containing poly alphaolefin (PAO)/2-ethylhexyl palmitate. The mixtures exhibit traditional flash point relationships, but an unexpected viscosity relationship.

### Example 3

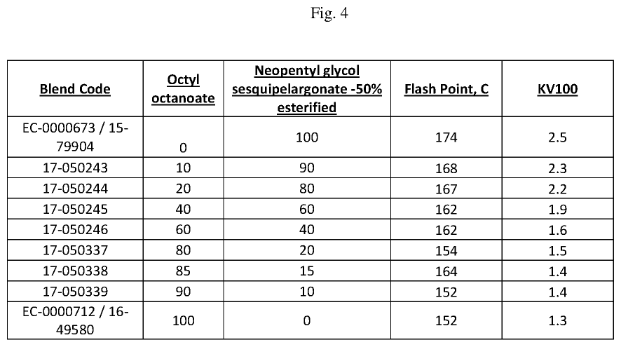

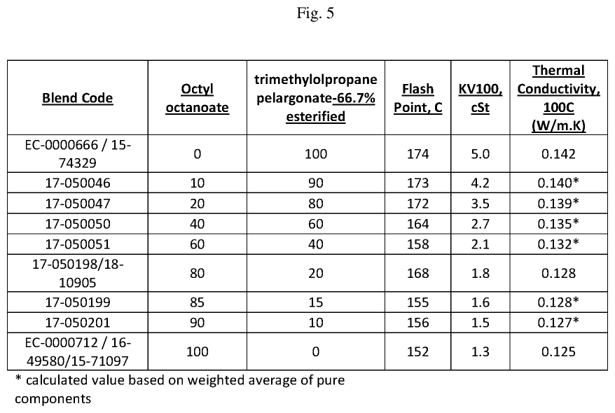

As shown in FIGS. 4 and 5, when linear monoesters (fully esterified) are mixed with mid to high-hydroxyesters (66.7% and 50% esterified), the viscosity relationship remains consistent with a traditional logarithmic correlation, however the flash point is elevated unexpectedly. Flash point was determined by ASTM D-93. Kinematic viscosity (KV₁₀₀) was determined by ASTM D-445.

FIG. 4 shows flash point and viscosity data for base stock mixtures containing octyl octanoate (fully esterified linear monoester)/neopentyl glycol sesquipelargonate (50% esterified). The mixtures exhibit traditional viscosity relationships, but an unexpected flash point relationship. In these blends, it is preferred to have 0 to 20% of neopentyl glycol sesquipelargonate (50% esterified).

FIG. 5 shows flash point and viscosity data for base stock mixtures containing octyl octanoate (fully esterified linear monoester)/trimethylolpropane pelargonate (66.7% esterified). The mixtures exhibit traditional viscosity relationships, but an unexpected flash point relationship. In these blends, it is preferred to have 0 to 15% of trimethylpropane pelargonate (66.7% esterified)

### Example 4

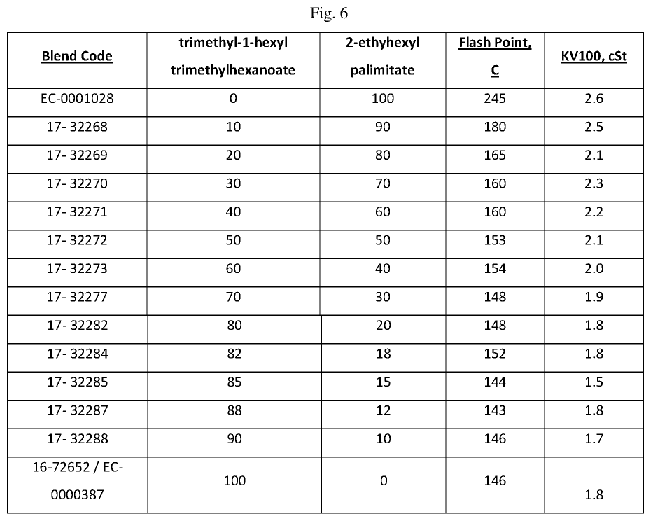

As shown in FIGS. 6-8, when branched esters (fully esterified) are mixed together or with mid-to high-hydroxyesters (50 to 66.7% esterified), flash point unexpectedly increases and viscosity unexpectedly decreases resulting in low volatility, low viscosity systems. Flash point was determined by ASTM D-93. Kinematic viscosity (KV₁₀₀) was determined by ASTM D-445.

FIG. 6 shows flash point and viscosity data for base stock mixtures containing trimethyl-1-hexyl trimethylhexanoate (fully esterified)/2-ethylhexyl palmitate (fully esterified). The mixtures exhibit an unexpected viscosity relationship and flash point relationship. In these blends, it is preferred to have 0 to 40% of 2-ehtylhexyl palmitate (fully esterified).

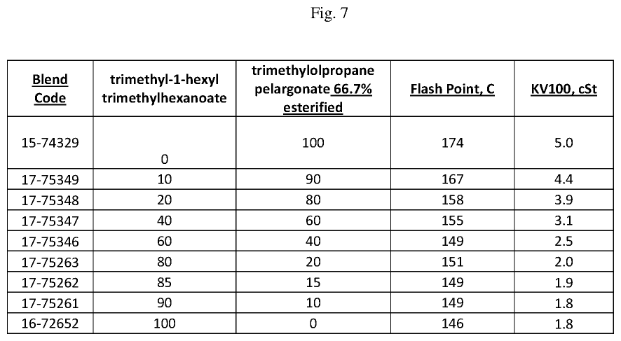

FIG. 7 shows flash point and viscosity data for base stock mixtures containing trimethyl-1-hexyl trimethylhexanoate (fully esterified)/trimethylolpropane pelargonate (66.7% esterified). The mixtures exhibit an unexpected viscosity relationship and flash point relationship. In these blends, it is preferred to have 0 to 20% of trimethylolpropane pelargonate (66.7% esterified).

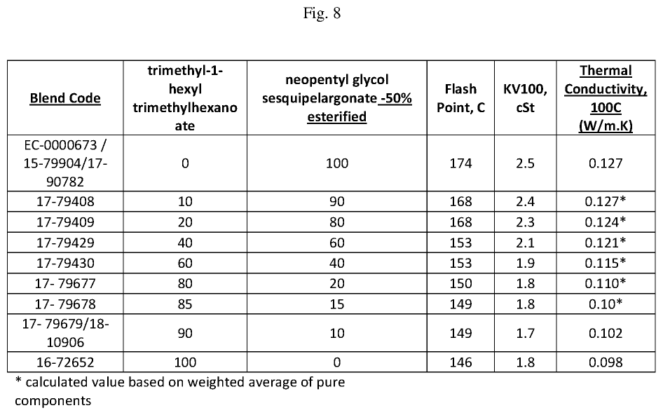

FIG. 8 shows flash point, viscosity, and thermal conductivity data for base stock mixtures containing trimethyl-1-hexyl trimethylhexanoate (fully esterified)/neopentyl glycol sesquipelargonate (50% esterified). The mixtures exhibit an unexpected viscosity relationship and flash point relationship. In these blends, it is preferred to have 0 to 40% neopentyl glycol sesquipelargonate (50% esterified).

### Example 5

In addition to imparting increased flash point and constant or diminished viscosity, the use of partially hydroxylated esters leads to an improvement in the thermal conductivity of the formulation. For example, trimethylolpropane pelargonate exhibits significantly higher thermal conductivity than other base oils of comparable viscosity. The combination of increased flash point and improved thermal conductivity at constant or decreased viscosity is very desirable from both a safety as well as a performance standpoint.

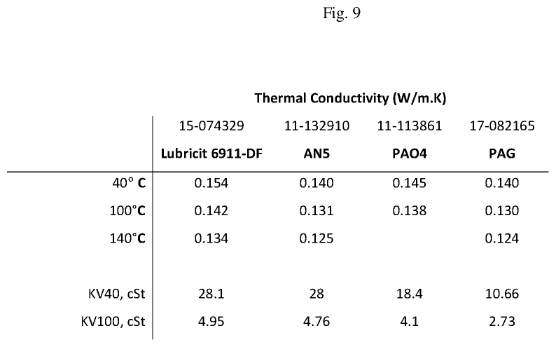

FIG. 9 shows thermal conductivity data for trimethylolpropane pelargonate, alkyl naphthalene, poly alphaolefin (PAO), and poly alkyleneglycol (PAG) base stocks. Thermal conductivity was determined by ASTM D-7896. Flash point was determined by ASTM D-93. Kinematic viscosity (KV₁₀₀) was determined by ASTM D-445.

### Example 6

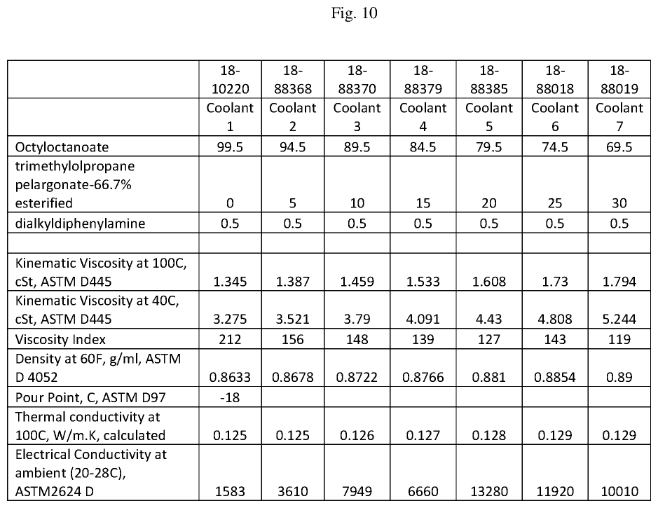

FIG. 10 shows a series of heat transfer fluids based on octyloctanoate and trimethylolpropane pelargonate—66.7% esterified, and a stabilizer dialkyldiphenylamine. Thermal conductivity was calculated based on the pure base oil components. Density was determined by ASTM D-7896. Flash point was determined by ASTM D-93. Kinematic viscosity (KV₁₀₀) was determined by ASTM D-445. Electrical conductivity was determined by ASTM D2624. In these blends, it is preferred to have 0 to 15% trimethylolpropane pelargonate (66.7% esterified) for minimal viscosity increase and an acceptable electrical conductivity range.

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

### Additional Embodiments

Embodiment 1. A heat transfer fluid comprising:

at least one first ester that is partially esterified; and

at least one second ester that is fully esterified;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the at least one first ester and the at least one second ester are present in an amount such that, as the flash point and thermal conductivity of said heat transfer fluid are increased, the kinematic viscosity (KV₁₀₀) of said heat transfer fluid is decreased or essentially maintained.

Embodiment 2. The heat transfer fluid of embodiment 1 wherein the at least one first ester is present in an amount from 1 to 40 weight percent, based on the total weight of the heat transfer fluid; and the at least one second ester is present in an amount from 60 to 99 weight percent, based on the total weight of the heat transfer fluid.

Embodiment 3. The heat transfer fluid of embodiment 1 wherein the at least one first ester has a high hydroxyl content, and wherein the hydroxyl content is from 0.1 to 1 free hydroxyl group per molecule.

Embodiment 4. The heat transfer fluid of embodiment 1 which has a freezing point of at least greater than −50° C. as determined by ASTM D1777-17, a boiling point of greater than 100° C. as determined by ASTM D1120-17, and a flash point of at least 150° C. as determined by ASTM D93.

Embodiment 5. The heat transfer fluid of embodiment 1 wherein the at least one first ester comprises at least one partially esterified polyol ester of a monocarboxylic acid.

Embodiment 6. The heat transfer fluid of embodiment 1 wherein the at least one first ester is derived by reacting one or more polyhydric alcohols with one or more monocarboxylic acids; wherein the one or more polyhydric alcohols comprise neopentyl glycol, trimethylol ethane, 2-methyl-2-propyl-1,3-propanediol, trimethylol propane, pentaerythritol, dipentaerythritol, tripentaerythritol, or tetrapentaerythritol; and wherein the one or more monocarboxylic acids comprise acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid, caprylic acid, capric acid, lauric acid, myristic acid, palmitic acid, stearic acid, arachic acid, behenic acid, or oleic acid.

Embodiment 7. The heat transfer fluid of embodiment 1 wherein the at least one first ester comprises partially esterified neopentyl glycol sesquipelargonate, partially esterified trimethylolpropane pelargonate, partially esterified neopentyl glycol ester, partially esterified 2-methyl-2-propyl-1,3-propanediol ester, partially esterified trimethylol ethane ester, partially esterified trimethylol propane ester, partially esterified pentaerythritol ester, partially esterified dipentaerythritol ester, partially esterified tripentaerythritol ester, or partially esterified tetrapentaerythritol ester.

Embodiment 8. The heat transfer fluid of embodiment 1 wherein the at least one second ester is derived by reacting one or more monoalkanoic acids with one or more monoalkanols; where the one or more monoalkanoic acids comprise butanoic acid, pentanoic acid, hexanoic acid, heptanoic acid, octanoic acid, nonanoic acid, decanoic acid, undeanoic acid, dodecanoic acid, tridecanoic acid, tetradecanoic acid, pentadecanoic acid, hexadecanoic acid, and their isomers; and wherein the one or more monalkanols comprise butyl alcohol, pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 9. The heat transfer fluid of embodiment 1 wherein the at least one second ester is derived by reacting one or more dibasic acids with one or more monoalkanols; wherein the one or more dibasic acids comprise phthalic acid, succinic acid, sebacic acid, fumaric acid, adipic acid, azelaic acid, linoleic acid dimer, malonic acid, alkyl malonic acid, or alkenyl malonic acid; and wherein the one or more monoalkanols comprise pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 10. The heat transfer fluid of embodiment 1 wherein the at least one second ester comprises dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, tripropylene glycol dipelargonate, 2-ethylhexyl palmitate, octyl octanoate, or trimethyl-1-hexyl trimethylhexanoate.

Embodiment 11. The heat transfer fluid of embodiment 1 wherein the at least one second ester comprises octyl octanoate

Embodiment 12. The heat transfer fluid of embodiment 1 which has a flash point from 130° C. to 220° C. as determined by ASTM D-93, a viscosity (Kv₁₀₀) from 1 to 4 at 100° C. as determined by ASTM D-445, and a Noack volatility of no greater than 50 percent as determined by ASTM D-5800.

Embodiment 13. The heat transfer fluid of embodiment 1 further comprising one or more of a mineral oil, synthetic oil, antioxidant, extreme-pressure additive, antiwear additive, friction reducing additive, defoaming agent, profoaming agent, metal deactivator, acid scavenger, corrosion inhibitor, thermal stabilizer, pH stabilizer or buffer, antiscaling agent, viscosity modifier, or biocide.

Embodiment 14. The heat transfer fluid of embodiment 1 further comprising one or more lubricating oils to form a bimodal blend, wherein the one or more lubricating oils comprise a Group I, Group II, Group III, Group IV, or Group V oil, and mixtures thereof.

Embodiment 15. The heat transfer fluid of embodiment 1 which is used in an electric vehicle.

Embodiment 16. A method for increasing flash point, while decreasing or essentially maintaining viscosity, of a heat transfer fluid by using as the heat transfer fluid a formulated heat transfer fluid comprising:

at least one first ester that is partially esterified; and

at least one second ester that is fully esterified;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the at least one first ester and the at least one second ester are present in an amount such that, as the flash point of said heat transfer fluid is increased, the kinematic viscosity (KV₁₀₀) of said heat transfer fluid is decreased or maintained.

Embodiment 17. The method of embodiment 16 wherein the at least one first ester is present in an amount from 1 to 40 weight percent, based on the total weight of the heat transfer fluid; and the at least one second ester is present in an amount from 60 to 99 weight percent, based on the total weight of the heat transfer fluid.

Embodiment 18. The method of embodiment 16 wherein the at least one first ester has a high hydroxyl content, and wherein the hydroxyl content is from 0.1 to 1 free hydroxyl group per molecule.

Embodiment 19. The method of embodiment 16 wherein the heat transfer fluid has a freezing point of at least greater than −50° C. as determined by ASTM D1777-17, a boiling point of greater than 100° C. as determined by ASTM D1120-17, and a flash point of at least 150° C. as determined by ASTM D93.

Embodiment 20. The method of embodiment 16 wherein the at least one first ester comprises at least one partially esterified polyol ester of a monocarboxylic acid.

Embodiment 21. The method of embodiment 16 wherein the at least one first ester is derived by reacting one or more polyhydric alcohols with one or more monocarboxylic acids; wherein the one or more polyhydric alcohols comprise neopentyl glycol, trimethylol ethane, 2-methyl-2-propyl-1,3-propanediol, trimethylol propane, pentaerythritol, dipentaerythritol, tripentaerythritol, or tetrapentaerythritol; and wherein the one or more monocarboxylic acids comprise acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid, caprylic acid, capric acid, lauric acid, myristic acid, palmitic acid, stearic acid, arachic acid, behenic acid, or oleic acid.

Embodiment 22. The method of embodiment 16 wherein the at least one first ester comprises partially esterified neopentyl glycol sesquipelargonate, partially esterified trimethylolpropane pelargonate, partially esterified neopentyl glycol ester, partially esterified 2-methyl-2-propyl-1,3-propanediol ester, partially esterified trimethylol ethane ester, partially esterified trimethylol propane ester, partially esterified pentaerythritol ester, partially esterified dipentaerythritol ester, partially esterified tripentaerythritol ester, or partially esterified tetrapentaerythritol ester.

Embodiment 23. The method of embodiment 16 wherein the at least one second ester is derived by reacting one or more monoalkanoic acids with one or more monoalkanols; where the one or more monoalkanoic acids comprise butanoic acid, pentanoic acid, hexanoic acid, heptanoic acid, octanoic acid, nonanoic acid, decanoic acid, undeanoic acid, dodecanoic acid, tridecanoic acid, tetradecanoic acid, pentadecanoic acid, hexadecanoic acid, and their isomers; and wherein the one or more monalkanols comprise butyl alcohol, pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 24. The method of embodiment 16 wherein the at least one second ester is derived by reacting one or more dibasic acids with one or more monoalkanols; wherein the one or more dibasic acids comprise phthalic acid, succinic acid, sebacic acid, fumaric acid, adipic acid, azelaic acid, linoleic acid dimer, malonic acid, alkyl malonic acid, or alkenyl malonic acid; and wherein the one or more monoalkanols comprise pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 25. The method of embodiment 16 wherein the at least one second ester comprises dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, tripropylene glycol dipelargonate, 2-ethylhexyl palmitate, octyl octanoate, or trimethyl-1-hexyl trimethylhexanoate.

Embodiment 26. The method of embodiment 16 wherein the heat transfer fluid has a flash point from 130° C. to 220° C. as determined by ASTM D-93, a viscosity (Kv₁₀₀) from 1 to 4 at 100° C. as determined by ASTM D-445, and a Noack volatility of no greater than 50 percent as determined by ASTM D-5800.

Embodiment 27. The method of embodiment 16 wherein the heat transfer fluid further comprises one or more of a mineral oil, synthetic oil, antioxidant, extreme-pressure additive, antiwear additive, friction reducing additive, defoaming agent, profoaming agent, metal deactivator, acid scavenger, corrosion inhibitor, thermal stabilizer, pH stabilizer or buffer, antiscaling agent, viscosity modifier, or biocide

Embodiment 28. The method of embodiment 16 wherein the heat transfer fluid further comprises one or more lubricating oils to form a bimodal blend, wherein the one or more lubricating oils comprise a Group I, Group II, Group III, Group IV, or Group V oil, and mixtures thereof.

Embodiment 29. The method of embodiment 16 in which the heat transfer fluid is used in an electric vehicle.

Embodiment 30. A method for increasing flash point and thermal conductivity, while decreasing or maintaining viscosity, of a heat transfer fluid by using as the heat transfer fluid a formulated heat transfer fluid comprising:

at least one partially esterified ester;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the heat transfer fluid has a thermal conductivity from 0.1 W/m·K to 0.2 W/m·K as determined by ASTM D-7896;

wherein the at least one partially esterified ester is present in an amount such that, as the flash point and thermal conductivity of said heat transfer fluid are increased, the kinematic viscosity (KV₁₀₀) of said heat transfer fluid is decreased or maintained.

Embodiment 31. The method of embodiment 30 wherein the at least one partially esterified ester is present in an amount from 1 to 40 weight percent, based on the total weight of the heat transfer fluid.

Embodiment 32. The method of embodiment 30 wherein the at least one partially esterified ester has a high hydroxyl content, and wherein the hydroxyl content is from 0.1 to 1 free hydroxyl group per molecule.

Embodiment 33. The method of embodiment 30 wherein the heat transfer fluid has a freezing point of at least greater than −50° C. as determined by ASTM D1777-17, a boiling point of greater than 100° C. as determined by ASTM D1120-17, and a flash point of at least 150° C. as determined by ASTM D93.

Embodiment 34. The method of embodiment 30 wherein the at least one partially esterified ester comprises at least one partially esterified polyol ester of a monocarboxylic acid.

Embodiment 35. The method of embodiment 30 wherein the at least one first ester is derived by reacting one or more polyhydric alcohols with one or more monocarboxylic acids; wherein the one or more polyhydric alcohols comprise neopentyl glycol, trimethylol ethane, 2-methyl-2-propyl-1,3-propanediol, trimethylol propane, pentaerythritol, dipentaerythritol, tripentaerythritol, or tetrapentaerythritol; and wherein the one or more monocarboxylic acids comprise acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid, caprylic acid, capric acid, lauric acid, myristic acid, palmitic acid, stearic acid, arachic acid, behenic acid, or oleic acid.

Embodiment 36. The method of embodiment 30 wherein the at least one first ester comprises partially esterified neopentyl glycol sesquipelargonate, partially esterified trimethylolpropane pelargonate, partially esterified neopentyl glycol ester, partially esterified 2-methyl-2-propyl-1,3-propanediol ester, partially esterified trimethylol ethane ester, partially esterified trimethylol propane ester, partially esterified pentaerythritol ester, partially esterified dipentaerythritol ester, partially esterified tripentaerythritol ester, or partially esterified tetrapentaerythritol ester.

Embodiment 37. The method of embodiment 30 wherein the heat transfer fluid further comprises at least one second ester that is derived by reacting one or more monoalkanoic acids with one or more monoalkanols; where the one or more monoalkanoic acids comprise butanoic acid, pentanoic acid, hexanoic acid, heptanoic acid, octanoic acid, nonanoic acid, decanoic acid, undeanoic acid, dodecanoic acid, tridecanoic acid, tetradecanoic acid, pentadecanoic acid, hexadecanoic acid, and their isomers; and wherein the one or more monalkanols comprise butyl alcohol, pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 38. The method of embodiment 30 wherein the heat transfer fluid further comprises at least one second ester that is derived by reacting one or more dibasic acids with one or more monoalkanols; wherein the one or more dibasic acids comprise phthalic acid, succinic acid, sebacic acid, fumaric acid, adipic acid, azelaic acid, linoleic acid dimer, malonic acid, alkyl malonic acid, or alkenyl malonic acid; and wherein the one or more monoalkanols comprise pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

Embodiment 39. The method of embodiment 30 wherein the heat transfer fluid further comprises at least one second ester that comprises dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, tripropylene glycol dipelargonate, 2-ethylhexyl palmitate, octyl octanoate, or trimethyl-1-hexyl trimethylhexanoate.

Embodiment 40. The method of embodiment 30 wherein the heat transfer fluid has a flash point from 130° C. to 220° C. as determined by ASTM D-93, a kinematic viscosity (KV₁₀₀) from 1 to 4 at 100° C. as determined by ASTM D-445, and a Noack volatility of no greater than 50 percent as determined by ASTM D-5800.

Embodiment 41. The method of embodiment 30 wherein the heat transfer fluid further comprises one or more of a mineral oil, synthetic oil, antioxidant, extreme-pressure additive, antiwear additive, friction reducing additive, defoaming agent, profoaming agent, metal deactivator, acid scavenger, corrosion inhibitor, thermal stabilizer, pH stabilizer or buffer, antiscaling agent, viscosity modifier, or biocide

Embodiment 42. The method of embodiment 30 wherein the heat transfer fluid further comprises one or more lubricating oils to form a bimodal blend, wherein the one or more lubricating oils comprise a Group I, Group II, Group III, Group IV, or Group V oil, and mixtures thereof.

Embodiment 43. The method of embodiment 30 in which the heat transfer fluid is a universal fluid for an electric vehicle.

Embodiment 44. A method of heat transfer in a heating and/or cooling system, said method comprising: (a) providing a composition comprising at least one base heat transfer fluid in the heating and/or cooling system; and (b) conducting heat transfer between the at least one base heat transfer fluid and the heating and/or cooling system; wherein the least one base heat transfer fluid comprises:

at least one first ester that is partially esterified; and

at least one second ester that is fully esterified;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the at least one first ester and the at least one second ester are present in an amount such that, as the flash point of said heat transfer fluid is increased, the kinematic viscosity (KV₁₀₀) of said heat transfer fluid is decreased or maintained.

Embodiment 45. A method of heat transfer comprising: (a) providing an object to be heated or cooled; and (b) transferring heat to or from the object to be heated or cooled by a composition comprising at least one base heat transfer fluid; wherein the least one base heat transfer fluid comprises:

at least one first ester that is partially esterified; and

at least one second ester that is fully esterified;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the at least one first ester and the at least one second ester are present in an amount such that, as the flash point of said heat transfer fluid is increased, the kinematic viscosity (KV₁₀₀) of said heat transfer fluid is decreased or maintained.

Embodiment 46. A blend composition for enhanced heat transfer fluid performance, said blend composition comprising: (i) at least one base heat transfer fluid, and (ii) one or more lubricating oils comprising a Group I, Group II, Group III, Group IV, or Group V oil;

wherein the least one base heat transfer fluid comprises:

at least one first ester that is partially esterified; and

at least one second ester that is fully esterified;

wherein the heat transfer fluid has a flash point from 125° C. to 225° C. as determined by ASTM D-93;

wherein the heat transfer fluid has a kinematic viscosity (KV₁₀₀) from 1 to 5 at 100° C. as determined by ASTM D-445; and

wherein the at least one first ester and the at least one second ester are present in an amount such that, as the flash point of said heat transfer fluid is increased, the kinematic viscosity (KV₁₀₀) of said heat transfer fluid is decreased or maintained.

The present disclosure has been described above with reference to numerous embodiments and specific examples. Many variations will suggest themselves to those skilled in this art in light of the above detailed description. All such obvious variations are within the full intended scope of the appended claims.

1. A heat transfer fluid comprising:
at least one first ester that is partially esterified; and
at least one second ester that is fully esterified;
wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the at least one first ester and the at least one second ester are present in an amount such that, as the flash point and thermal conductivity of said heat transfer fluid are increased, the kinematic viscosity (KV₁₀₀) of said heat transfer fluid is decreased or essentially maintained.

2. The heat transfer fluid of claim 1 wherein the at least one first ester is present in an amount from 1 to 40 weight percent, based on the total weight of the heat transfer fluid; and the at least one second ester is present in an amount from 60 to 99 weight percent, based on the total weight of the heat transfer fluid.

3. The heat transfer fluid of claim 1 wherein the at least one first ester has a high hydroxyl content, and wherein the hydroxyl content is from 0.1 to 1 free hydroxyl group per molecule.

4. The heat transfer fluid of claim 1 which has a freezing point of at least greater than −50° C. as determined by ASTM D1777-17, a boiling point of greater than 100° C. as determined by ASTM D1120-17, and a flash point of at least 150° C. as determined by ASTM D93.

5. The heat transfer fluid of claim 1 wherein the at least one first ester comprises at least one partially esterified polyol ester of a monocarboxylic acid.

6. The heat transfer fluid of claim 1 wherein the at least one first ester is derived by reacting one or more polyhydric alcohols with one or more monocarboxylic acids; wherein the one or more polyhydric alcohols comprise neopentyl glycol, trimethylol ethane, 2-methyl-2-propyl-1,3-propanediol, trimethylol propane, pentaerythritol, dipentaerythritol, tripentaerythritol, or tetrapentaerythritol; and wherein the one or more monocarboxylic acids comprise acetic acid, propionic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, 3-methylbutanoic acid, 2-methylbutanoic acid, 2-ethylhexanoic acid, 2,4-dimethylpentanoic acid, 3,3,5-trimethylhexanoic acid, benzoic acid, caprylic acid, capric acid, lauric acid, myristic acid, palmitic acid, stearic acid, arachic acid, behenic acid, or oleic acid.

7. The heat transfer fluid of claim 1 wherein the at least one first ester comprises partially esterified neopentyl glycol sesquipelargonate, partially esterified trimethylolpropane pelargonate, partially esterified neopentyl glycol ester, partially esterified 2-methyl-2-propyl-1,3-propanediol ester, partially esterified trimethylol ethane ester, partially esterified trimethylol propane ester, partially esterified pentaerythritol ester, partially esterified dipentaerythritol ester, partially esterified tripentaerythritol ester, or partially esterified tetrapentaerythritol ester.

8. The heat transfer fluid of claim 1 wherein the at least one second ester is derived by reacting one or more monoalkanoic acids with one or more monoalkanols; where the one or more monoalkanoic acids comprise butanoic acid, pentanoic acid, hexanoic acid, heptanoic acid, octanoic acid, nonanoic acid, decanoic acid, undeanoic acid, dodecanoic acid, tridecanoic acid, tetradecanoic acid, pentadecanoic acid, hexadecanoic acid, and their isomers; and wherein the one or more monalkanols comprise butyl alcohol, pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

9. The heat transfer fluid of claim 1 wherein the at least one second ester is derived by reacting one or more dibasic acids with one or more monoalkanols; wherein the one or more dibasic acids comprise phthalic acid, succinic acid, sebacic acid, fumaric acid, adipic acid, azelaic acid, linoleic acid dimer, malonic acid, alkyl malonic acid, or alkenyl malonic acid; and
wherein the one or more monoalkanols comprise pentyl alcohol, hexyl alcohol, heptyl alcohol, octyl alcohol, nonyl alcohol, decyl alcohol, dodecyl alcohol, tridecyl alcohol, tetradecyl alcohol, pentadecyl alcohol, hexadecyl alcohol, and their isomers.

10. The heat transfer fluid of claim 1 wherein the at least one second ester comprises dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, tripropylene glycol dipelargonate, 2-ethylhexyl palmitate, octyl octanoate, or trimethyl-1-hexyl trimethylhexanoate.

11. A method for increasing flash point, while decreasing or essentially maintaining viscosity, of a heat transfer fluid by using as the heat transfer fluid a formulated heat transfer fluid comprising:
at least one first ester that is partially esterified; and
at least one second ester that is fully esterified;
wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the at least one first ester and the at least one second ester are present in an amount such that, as the flash point of said heat transfer fluid is increased, the kinematic viscosity (KV₁₀₀) of said heat transfer fluid is decreased or maintained.

12. A method for increasing flash point and thermal conductivity, while decreasing or maintaining viscosity, of a heat transfer fluid by using as the heat transfer fluid a formulated heat transfer fluid comprising:
at least one partially esterified ester;
wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the heat transfer fluid has a thermal conductivity from 0.1 W/m·K to 0.2 W/m·K as determined by ASTM D-7896;
wherein the at least one partially esterified ester is present in an amount such that, as the flash point and thermal conductivity of said heat transfer fluid are increased, the kinematic viscosity (KV₁₀₀) of said heat transfer fluid is decreased or maintained.

13. A method of heat transfer in a heating and/or cooling system, said method comprising: (a) providing a composition comprising at least one base heat transfer fluid in the heating and/or cooling system; and (b) conducting heat transfer between the at least one base heat transfer fluid and the heating and/or cooling system; wherein the least one base heat transfer fluid comprises:
at least one first ester that is partially esterified; and
at least one second ester that is fully esterified;
wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the at least one first ester and the at least one second ester are present in an amount such that, as the flash point of said heat transfer fluid is increased, the kinematic viscosity (KV₁₀₀) of said heat transfer fluid is decreased or maintained.

14. A method of heat transfer comprising: (a) providing an object to be heated or cooled; and (b) transferring heat to or from the object to be heated or cooled by a composition comprising at least one base heat transfer fluid; wherein the least one base heat transfer fluid comprises:
at least one first ester that is partially esterified; and
at least one second ester that is fully esterified; wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the at least one first ester and the at least one second ester are present in an amount such that, as the flash point of said heat transfer fluid is increased, the kinematic viscosity (KV₁₀₀) of said heat transfer fluid is decreased or maintained.

15. A blend composition for enhanced heat transfer fluid performance, said blend composition comprising: (i) at least one base heat transfer fluid, and (ii) one or more lubricating oils comprising a Group I, Group II, Group III, Group IV, or Group V oil;
wherein the least one base heat transfer fluid comprises:
at least one first ester that is partially esterified; and
at least one second ester that is fully esterified;
wherein the heat transfer fluid has a flash point from 125° C. to 225° C. as determined by ASTM D-93;
wherein the heat transfer fluid has a kinematic viscosity (KV₁₀₀) from 1 to 5 at 100° C. as determined by ASTM D-445; and
wherein the at least one first ester and the at least one second ester are present in an amount such that, as the flash point of said heat transfer fluid is increased, the kinematic viscosity (KV₁₀₀) of said heat transfer fluid is decreased or maintained.
